(19) United States
(12) Patent Application Publication
(10) Pub. No.: US 2020/0365932 A1
(43) Pub. Date: Nov. 19, 2020

(54) BATTERY MODULE FOR A MOTOR VEHICLE

(71) Applicant: VOLKSWAGEN AKTIENGESELLSCHAFT, Wolfsburg (DE)

(72) Inventors: Bastian SCHAAR, Braunschweig (DE); Nicolas WOLFF, Braunschweig (DE)

(73) Assignee: VOLKSWAGEN AKTIENGESELLSCHAFT, Wolfsburg (DE)

(21) Appl. No.: 16/876,743

(22) Filed: May 18, 2020

(30) Foreign Application Priority Data
May 17, 2019 (DE) 10 2019 207 207.0

(51) Int. Cl. H01M 10/04; H01M 10/0525; H01M 2/10; H01M 2/20; H01M 2/30; H01M 2/02; B60L 50/60

(52) U.S. Cl. CPC H01M 10/0422; H01M 10/0525; H01M 2/1077; H01M 2220/20; H01M 2/305; H01M 2/0237; B60L 50/60; H01M 2/206

(57) ABSTRACT

A battery module comprises at least one battery cell and a cell mount, whereby the battery cell has a cylindrical cell housing with an external lateral surface, whereby an external thread is created in the lateral surface, and whereby the cell mount has at least one threaded hole with an internal thread into which the at least one battery cell is screwed in or can be screwed in.

### FIELD OF THE INVENTION

The present invention relates to a battery module, for example, for a motor vehicle, especially for a motor vehicle that is or can be powered electrically such as, for instance, an electric or hybrid vehicle. The invention also relates to a battery cell for such a battery module as well as to a motor vehicle that is or can be powered electrically and that has such a battery module.

### BACKGROUND OF THE INVENTION

Motor vehicles that are or can be powered electrically or electromotively such as, for example, electric or hybrid vehicles, normally comprise an electric motor with which one or both vehicle axles can be driven. When it comes to the supply of electricity, the electric motor is usually connected to an on-board (high-voltage) vehicle battery that serves as the electric energy storage unit.

As set forth here and below, the term electrochemical battery specifically refers to a so-called secondary battery of the motor vehicle. With such a (secondary) vehicle battery, the consumed chemical energy can be restored by means of an electric (re-)charging procedure. Such vehicle batteries are configured, for instance, as electrochemical batteries, especially as lithium-ion batteries. In order to generate or provide an operating voltage that is sufficiently high, such motor vehicle batteries typically have at least one battery module (battery cell module) in which several individual battery cells are modularly interconnected.

The battery cells can be configured, for example, as so-called button cells or as cylindrical cells. As a rule, such button cells have a round or cylindrical shape with a (circular-) cylindrical housing.

When a motor vehicle battery consists of button cells, it is often necessary to couple more than a thousand individual battery cells to form a battery module. Due to the large number of battery cells, a great deal of production effort is required to handle them during the assembly, to secure them in the module group and to create the vehicle-appropriate connection in the battery module as well as to establish the final electric contacting. This detrimentally increases the production time and the production costs of such battery modules.

The battery cells or button cells are typically secured or attached in the battery module in that a pre-assembled array of the battery cells is integrally bonded or glued with a casting compound (for example, casting resin). Subsequently, the technique of wire bonding is employed to contact the individual battery cells with each other so that they are electrically conductive.

When it comes to such a battery module having cast or integrally bonded battery cells, it is quite difficult or even impossible to dismantle them later for maintenance, repair or recycling purposes.

Moreover, during the production of the battery module, it is frequently necessary for the casting compound to be applied to the battery cells at a high temperature. This gives rise to the problem that the battery cells start to degenerate at a high temperature, for instance, of more than 45° C. This means that such elevated temperatures cause electrochemical reactions inside the battery cells which damage or completely destroy them. For this reason, it is necessary for the casting to be carried out under controlled conditions since, on the one hand, the temperature of the casting compound has to be sufficiently high to ensure good flow and wetting behavior but, on the other hand, degeneration of the battery cells has to be avoided. This detrimentally increases the manufacturing work involved with the battery module.

Each battery cell has two poles, namely, a negative pole and a positive pole, as the electric contacting or connecting sites, so that, within the scope of the electric contacting of the battery cells, two wire bonding steps are needed for each battery cell. This translates into a great deal of interconnecting work for the battery cells of the battery module, and this has a detrimental impact on the production time.

German patent application DE 101 22 682 A1 discloses a cell module structure for a battery module having several battery cells configured as button cells. The cell module structure has a mount plate with a number of connectors that serve for contacting the battery cells. The connectors are configured as projecting threaded parts with an external thread. The battery cells have a cell connector on their end face in which an internal thread has been created. In order to assemble the battery module, the battery cells are placed onto the connectors and the threads are screwed together.

German patent application DE 10 2015 210 671 A1 describes a battery module with a plurality of battery cells configured as button cells. The cell poles of the battery cells here are arranged coaxially to each other on a shared end face of the cell housing. In this context, the cell poles of the battery cells each have a thread that can be screwed into a mating thread of a battery module cover.

### SUMMARY OF THE INVENTION

The invention is based on the objective of putting forward a highly suitable battery module. In particular, a battery module is to be put forward which calls for very little assembly and interconnecting work. The invention is also based on the objective of putting forward a battery cell for such a battery module as well as a motor vehicle that is or can be powered electrically and that has such a battery module.

The objective is achieved according to the invention by means of the features of an independent claim regarding the battery module, by means of the features of an independent claim regarding the battery cell, and by means of the features of an independent claim regarding the motor vehicle. Advantageous embodiments and refinements are the subject matter of the subordinate claims. The advantages and embodiments cited in conjunction with the battery module can also be correspondingly applied to the battery cell and/or to the motor vehicle and vice versa.

The battery module according to the invention is suitable and designed, for instance, for a stationary energy storage unit. Preferably, the battery module is suitable and designed for an on-board energy storage unit, in other words, for a vehicle battery of a motor vehicle that is or can be powered electrically. The battery module has at least one battery cell and one cell mount (module mount, mount block) as the cell connector.

The battery cell has a cylindrical cell housing with an external lateral surface. In other words, the battery cell is configured as a button cell or as a cylindrical cell. In the lateral surface of the cell housing, there is an external thread or screw thread, at least in certain sections, that is to say, a profiled groove that runs continuously in a spiral, in other words, in the form of a helical line.

In this context, the cell mount has at least one threaded hole with an internal thread into which the at least one battery cell is twisted in (screwed in, inserted) or can be twisted in (screwed in, inserted). This means that the internal thread of the threaded hole is configured to mate or intermesh with the external thread of the cell housing, in other words, the threaded hole and the battery cell constitute a matching pair. This yields a highly suitable battery module.

Therefore, the external thread of the battery cell is screwed into the threaded hole of the cell mount for purposes of assembling the battery module. This means that the battery module can be assembled very easily and with less effort. This especially also allows a simplified dismantling of individual battery cells for maintenance, repair or recycling.

Thanks to the external thread of the battery cell on the one hand and the internal thread of the threaded hole of the cell mount on the other hand, the battery cell is non-positively held or secured on the cell mount. As set forth here and below, the term “non-positive” or “non-positive connection” between at least two parts joined to each other refers to the fact that the parts that are joined together are prevented from sliding off each other due to the frictional force that acts between them. If a “connecting force” (this refers to the force that presses the parts against each other, for example, a screw force or the force of the weight itself) that brings about this frictional force is absent, then the non-positive connection cannot be maintained and is thus released.

In this context, the external and internal threads of the cell housing or of the cell mount are made, for example, with a cutting technique by means of mechanical (post-)processing, or else with a non-cutting (shaping) technique by means of casting or additive manufacturing methods.

In contrast to the state of the art, the non-positive threaded or screwed connection is made not only in the area of an end face of the cell housing, but also, along its lateral surface. As a result, in comparison to the state of the art, a considerably greater engagement of the thread, in other words, a lengthened connecting or joining area between the battery cell and the cell mount, is made possible. This yields an operationally secure, vibration-resistant and shock-resistant connection between the at least one battery cell and the cell mount.

In an advantageous embodiment, the external thread extends essentially over the entire axial height of the cell housing. In other words, the cell housing is configured along the lines of a threaded bolt. This translates into a very long and large connecting or joining surface area, thereby ensuring an operationally secure, vibration-resistant and shock-resistant connection between the at least one battery cell and the cell mount.

Preferably, the axial depth of the threaded hole is sufficient to ensure that the battery is or can be screwed into the threaded hole as completely as possible.

In a suitable refinement, a cell pole, that is to say, the positive pole or the negative pole, of the battery cell is connected to the cell housing. This means that the cell housing, particularly the external thread, effectively forms one of the cell poles of the battery cell. This allows very easy contacting of the battery cell.

The other cell pole is then contacted, for example, by means of wire bonding or by means of (laser) welding. It is likewise conceivable, for instance, to have a contact site at the bottom of the threaded hole, for example, in the manner of a spring contact, which results in an even greater simplification of the assembly of the battery module.

In a possible embodiment, the cell mount is at least partially made of an electrically conductive material. This electrically conductive material is, for example, a metal, especially a copper or aluminum material. In this context, for instance, the cell mount can have a lead frame or a conductor rail made of the electrically conductive material which is integrated into an electrically non-conductive mount material, for instance, in the form of an insert. This allows the battery cells to be contacted and/or interconnected very simply and with less effort. The conjunction “and/or” as set forth here and below indicates that the features linked by this conjunction can be configured in combination with each other or else as alternatives to each other.

Alternatively, it is conceivable, for instance, for the cell mount to be made of an electrically non-conductive material, for example, a plastic material. The cell mount here is made, for instance, of an ABS (acrylonitrile butadiene styrene) copolymer or of a PP (polypropylene) plastic material, if necessary also with fiberglass reinforcement (e.g. PP GF 30). This accounts for a marked reduction in the construction weight and costs of the battery module.

In a particularly practical embodiment, the battery cell is contacted so as to be electrically conductive when it has been screwed in. This means that screwing or twisting the battery cells into the threaded hole of the cell mount effectuates the electric contacting of at least one cell pole of the battery cells. In the case of several battery cells that have been screwed into the cell mount, the contacted cell poles are preferably electrically connected in parallel. In comparison to the state of the art, this eliminates, for instance, half of the wire bonding steps needed for the contacting and/or interconnecting since one cell pole of the battery cell is already contacted when it is screwed into the threaded hole.

These especially electrochemical battery cells are configured, for instance, as lithium-ion battery cells. As a rule, such battery cells have an efficiency of about 95%, whereby the losses that occur are converted into thermal energy. Therefore, when it comes to attaining an efficient and reliable use of the battery module in a motor vehicle, it is necessary for the operating temperature of the battery cells to be set, for example, at 25° C. during operation since, on the one hand, degeneration sets in at battery temperatures higher than 45° C. and, on the other hand, the performance of lithium-ion battery cells diminishes below −5° C.

For purposes of temperature control or temperature management, and thus in order to attain the best possible performance-optimized operation of the battery, in a suitable embodiment, at least one coolant channel, in other words, a channel structure provided for conveying cooling or heating fluids, is integrated into the cell mount, said channel surrounding the at least one threaded hole. This permits a high-performance control of the temperature close to the battery cells.

In the assembled or installed state, the at least one coolant channel is suitably connected to a corresponding (external) coolant circuit, whereby a cooling or heating medium flows through said channel. This ensures an effective and operationally reliable cooling and/or heat storage for the battery cells of the battery module, as a result of which the service life of the battery cells and thus of the battery module is prolonged.

In an additional and/or alternative embodiment, for purposes of the temperature control or temperature management of the battery cells, it is provided that, in the vicinity of the threaded hole or of each threaded hole, a phase change material (PCM) is integrated into the cell mount as a latent heat system (LHS) which retains a solid structure during a phase transition. This means that the phase change material is a solid-state material before as well as after the phase transition, in other words, it does not become liquefied during the phase transition.

In this context, the cell mount is especially made of a PCM matrix material. This increases the heat capacity of the cell mount. Consequently, for instance, heat as well as cold can be withdrawn from the surrounding cell mount material and/or from the battery cells and can be stored accordingly. Owing to the inserted or installed PCM, it is possible, for example, to compensate for fluctuations in the battery temperature and/or to stabilize the battery temperature. Consequently, heat peaks in the battery temperature are prevented essentially passively, without the need to actively cool the battery cell or the cell mount.

In a conceivable refinement, a number of threaded holes are arranged in a centered-rectangular or hexagonal grid pattern in the cell mount. In other words, adjacent rows of threaded holes are arranged offset with respect to each other, so that an arrangement of the battery cells is achieved that is very spatially compact. This advantageously reduces the space needed for the battery module, which is particularly advantageous in terms of the installation space or application situations in a motor vehicle.

The battery cell according to the invention is suitable and designed for a battery module of the type described above. The battery cell is configured as a button cell or cylindrical cell having a cylindrical cell housing, whereby an external thread or screw thread is created in an outer lateral surface of the cell housing.

The battery cell can be screwed into a threaded hole of a cell mount of the battery module, a process in which the battery cell is non-positively secured on the cell mount, and it is preferably contacted or interconnected so as to be electrically conductive. This means that the battery module can be assembled and interconnected very easily and with less effort. This especially also allows a simplified dismantling of individual battery cells from the battery module during maintenance, repair or recycling.

In a preferred use, the battery module described above is part of the battery of a motor vehicle that is or can be powered electrically, especially a hybrid or electric vehicle. Thanks to the battery module according to the invention, the production effort and thus the production costs for the motor vehicle are advantageously reduced.

### BRIEF DESCRIPTION OF THE DRAWINGS

Below, an embodiment of the invention will be elaborated upon in greater detail. The following is shown in schematic and simplified depictions:

FIG. 1 is a section of a motor vehicle battery, with several battery modules, each with a number of battery cells;

FIG. 2 is a sectional view of a battery cell; and

FIG. 3 is a top view of a cell mount of the battery module with threaded holes and integrated coolant channels.

Corresponding parts and dimensions are consistently provided with the same reference numerals in all of the figures.

### DETAILED DESCRIPTION OF THE INVENTION

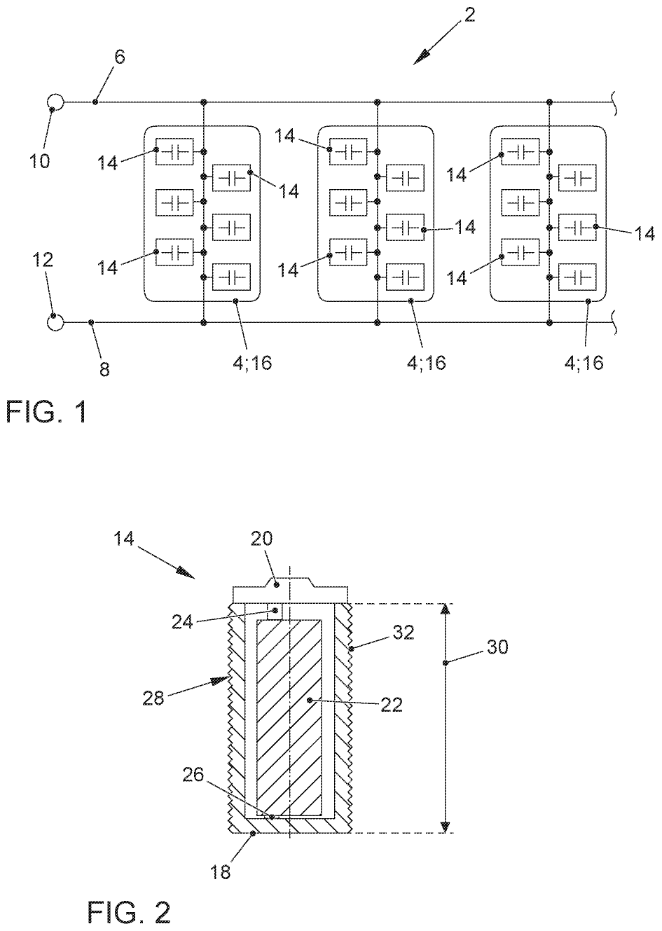

FIG. 1 shows a section of a simplified and schematic view of a battery 2 of a motor vehicle (not shown in greater detail). The (vehicle) battery 2 is particularly configured as an electrochemical secondary battery, whereby the motor vehicle is especially a motor vehicle that is or can be powered electrically, for instance, an electric or hybrid vehicle.

The battery 2 has a plurality of battery modules 4 which are configured, for example, as lithium-ion batteries. By way of an example, FIG. 1 only shows three battery modules 4 connected in parallel, each of which is connected on the one hand to a positive path 6 and, on the other hand to a negative path 8. The paths 6, 8 each run to a corresponding connector 10, 12 of the battery 2.

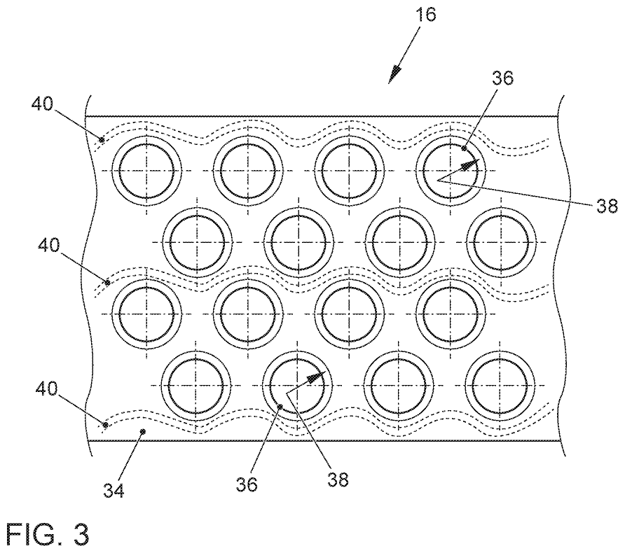

In FIG. 1, the battery modules 4 are shown merely by way of an example with six individual battery cells 14 each (FIG. 2). The battery cells 14 are arranged adjacent to each other in the battery module 4, and they are jointly interconnected to the battery module 4. The battery cells 14 provided with reference numerals in FIG. 1 are shown merely by way of an example. In order to secure and contact the battery cells 14, each battery module 4 has a cell mount (module mount block) 26 as the cell connector (FIG. 3).

The battery cells 4 shown individually in FIG. 2 are configured as button cells or cylindrical cells. In this context, the battery cell or cells has/have a cylindrical housing 18 that is closed at the end face by means of a cell cover 20. An electrode winding 22 is arranged inside the cell housing 18. The electrode winding 22 has two cell poles 24, 26, that is to say, a positive pole 24 and a negative pole 26. The positive pole 24 is contacted to the cell cover 20. Here, on the opposing end face of the cell housing 18, the negative pole 26 is contacted to a housing base. In other words, the negative pole 26 is connected to the cell housing 18. This means that the positive pole of the battery cell 14 is essentially formed by the cell cover 20, while the negative pole of the battery cell 14 is essentially formed by the cell housing 18. In this context, the cell cover 20 and the cell housing 18 are advantageously electrically insulated from each other. As an alternative, it is conceivable, for instance, for the positive pole 24 to be connected to the cell housing 18 and for the negative pole 26 to be connected to the cell cover 20.

The cell housing 18 has an external lateral surface 28 with an axial cell height 30. An external thread 32 has been created in the lateral surface 28 and it extends essentially over the entire axial cell height 30 of the cell housing 18.

The cell mount 16, of which only a section is shown in FIG. 3, has a mount element 34 in which a number of threaded holes 36 have been created. The threaded holes 36 here each have an internal thread 38 which is configured so as to mate with the external thread 32. In FIG. 3, the threaded holes are provided with reference numerals only by way of an example.

The mount element 34 is made, for example, of a phase change matrix material, whereby the phase change matrix retains a solid structure during a phase transition. In this context, the mount element 34 is made at least partially of an electrically conductive material. Here, for example, a lead frame that runs on the threaded holes 36 or on their internal threads 38 is integrated into the mount element 34.

For purposes of assembling the battery module 4, the battery cells 14 are twisted or screwed by means of their external thread 32 into the internal thread 38 of the threaded holes 36 of the cell mount 16. Due to the contacting of the cell pole 26 to the cell housing 18, and due to the electrically conductive material of the mount element 34, when the battery cells 14 are screwed in, on the one hand, they are non-positively secured to the cell mount 16 and, on the other hand, they are electrically interconnected to each other. In particular, the battery cells 14 here are coupled to each other by means of an electric parallel connection so as to be electrically conductive.

In the section depicted in FIG. 3, four rows of threaded holes 36 are shown, said rows each being arranged offset relative to each other, so that the threaded holes 36 have an approximately centered-rectangular or hexagonal grid pattern in the mount element 34.

Coolant channels 40 surround the threaded holes 36, said channels being integrated into the mount element 34. The coolant channels 40 are indicated in FIG. 3 by means of broken lines. In this context, the coolant channels 40 are configured with a wavy or meandering course around the threaded holes 36, so that each threaded hole 36 is surrounded or enclosed by a coolant channel 40, at least in some sections. Here, the coolant channels 40 can be configured, for instance, as a continuous coolant channel, in other words, as a one-part coolant channel, or else as separate, parallel coolant channels.

In the assembled or installed state, the coolant channels 40 are connected to a coolant circuit of the battery 2 and/or of the motor vehicle, and a cooling or heating medium flows through said channels. The spatially compact grid pattern of the threaded holes 36 and the phase change matrix material of the mount element 34 as well as the coolant channels 40 translate into a very effective, reliable and operationally safe temperature management of the battery cells 14, thus ensuring a high-performance temperature control close to the battery cells 14 of the battery module 4 during operation.

The invention being claimed here is not restricted to the embodiment described above. Rather, the person skilled in the art can also derive other variants of the invention within the scope of the disclosed claims without departing from the subject matter of the invention being claimed here. In particular, all of the individual features described in conjunction with the embodiment within the scope of the disclosed claims can also be combined in a different manner without departing from the subject matter of the invention being claimed here.

### LIST OF REFERENCE NUMERALS

2 vehicle battery
4 battery module
6 positive path
8 negative path
10 connector
12 connector
14 battery cell
16 cell mount
18 cell housing
20 cell cover
22 electrode winding
24 cell pole/positive pole
26 cell pole/negative pole
28 lateral surface
30 cell height
32 external thread
34 mount element
36 threaded hole
38 internal thread
40 coolant channel

1. A battery module, comprising:
at least one battery cell, whereby the battery cell has a cylindrical cell housing with an external lateral surface, and an external thread in the lateral surface, and
a cell mount, whereby the cell mount has at least one threaded hole with an internal thread into which the at least one battery cell is configured to be screwed in.

2. The battery module according to claim 1, wherein the external thread extends essentially over an entire axial height of the cell housing.

3. The battery module according to claim 1, wherein a cell pole of the battery cell is connected to the cell housing.

4. The battery module according to claim 1, wherein the cell mount is at least partially made of an electrically conductive material.

5. The battery module according to claim 1, wherein the battery cell is contacted so as to be electrically conductive when it has been screwed in.

6. The battery module according to claim 1, further comprising a coolant channel integrated into the cell mount, said coolant channel surrounding the at least one threaded hole.

7. The battery module according to claim 1, further comprising a phase change material, which retains a solid structure during a phase transition, integrated into the cell mount.

8. The battery module according to claim 1, further comprising a number of threaded holes arranged in a centered-rectangular or hexagonal grid pattern in the cell mount.

9. A battery cell for a battery module according to claim 1, comprising a cylindrical cell housing that has an outer lateral surface in which an external thread is created.

10. A motor vehicle configured to be powered electrically, comprising a motor vehicle battery with a battery module according to claim 1.
